(19) United States
(12) Patent Application Publication
(10) Pub. No.: US 2026/0285233 A1
(43) Pub. Date: Sep. 24, 2026

(54) TRAILER AND STAIRS

(71) Applicants: CCIP PTY LTD, Maudsland, Queensland (AU); KRBIP PTY LTD, Jacobs Well, Queensland (AU)

(72) Inventors: Cameron CROSS, Maudsland, Queensland (AU); Kirk BUCKLEY, Jacobs Well, Queensland (AU)

(73) Assignees: CCIP PTY LTD, Maudsland, Queensland (AU); KRBIP PTY LTD, Jacobs Well, Queensland (AU)

(21) Appl. No.: 19/469,945

(22) PCT Filed: Mar. 29, 2023
(86) PCT No.: PCT/AU2023/050230

§ 371 Date: Sep. 26, 2025

(30) Foreign Application Priority Data
Sep. 30, 2022 (AU) 2022241583

(51) Int. Cl. B60R 3/00; B60N 3/02; B60P 3/38; B60R 3/02; B60R 5/02

(52) U.S. Cl. CPC B60R 3/00; B60N 3/02; B60R 3/007; B60R 3/02; B60R 5/02; B60P 3/38

(57) ABSTRACT

A set of stairs arranged for mounting at a front of a trailer with a base adapted to be attached to a chassis of the trailer and stair flights leading up to a top of the trailer, each flight having a riser and a tread rigidly fixed relative to the base. The invention also relates to a trailer with a chassis and the set of stairs mounted to the chassis, at a front of the trailer.

### FIELD

The present invention relates to a set of stairs and a trailer particularly but not exclusively a camper trailer.

### BACKGROUND

Camper trailers are known with an accommodation section or tent which sits on top of the trailer. The accommodation section is able to be expanded from a collapsed condition to an assembled condition to provide accommodation on top of the trailer. The accommodation section is accessed from either a side of the trailer or a rear of the trailer using a ladder, which is generally quite unstable and insecure and can present a fall hazard when entering and exiting the accommodation section.

### OBJECT

The present invention seeks to provide a more secure means of accessing a top of a trailer.

### SUMMARY

In one aspect, the invention provides a set of stairs arranged for mounting at a front of a trailer with a base adapted to be attached to a chassis of the trailer and stair flights leading up to a top of the trailer, each flight having a riser and a tread rigidly fixed relative to the base.

In one example, one or more of the risers includes a panel to access a storage space beneath a respective tread.

In one example, the set of stairs includes fixed handrails that extend up to the top of the trailer.

In one example, the set of stairs includes one or more side compartments for holding a gas bottle or the like.

In another aspect, there is provided a trailer with the above described stairs mounted to a chassis of the trailer.

In one example, a stepping plate is fixed across the chassis between a tow bar and the set of stairs to provide a stable platform to climb the stairs.

In one example, the trailer includes a step ladder which is attached to a bracket connected to a beam of the chassis to provide access from a ground surface onto the stepping plate.

In one example, the step ladder is collapsible and able to be removed from the bracket for transport.

In one example, the trailer includes an accommodation section on the top of the trailer, the accommodation section being moveable between a collapsed and assembled condition with an entry at the front of the trailer, adjacent an upper tread of the set of stairs.

### BRIEF DESCRIPTION OF THE DRAWINGS

The invention is described in more detail, by way of non-limiting example only, with reference to the accompanying drawings, in which:

FIG. 1 is a perspective view of a trailer and set of stairs.

### DETAILED DESCRIPTION OF THE DRAWINGS

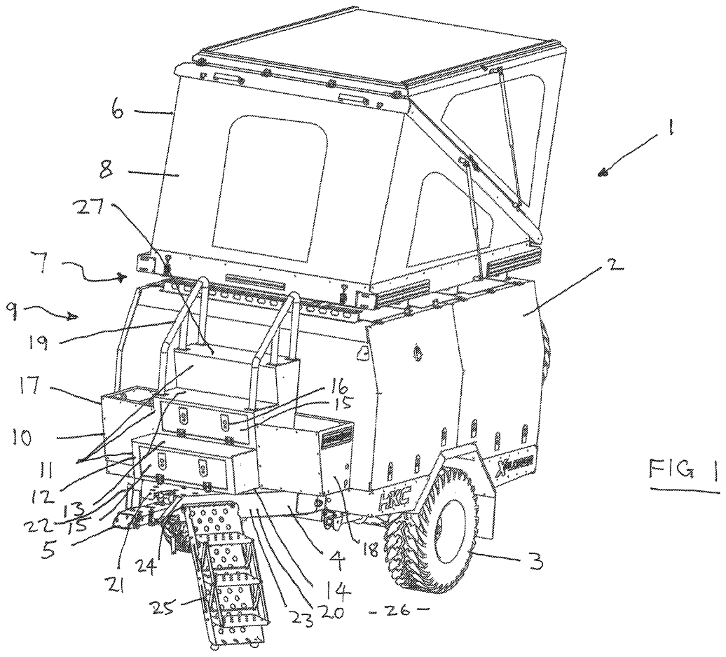

A trailer 1 is shown in FIG. 1. The trailer has a main body 2, wheels 3 and a chassis 4 with a tow bar 5. The main body 2 supports an accommodation section 6 at a top 7 of the trailer 1.

The accommodation section 6 is shown in an assembled condition and is able to be collapsed flat for transport. The accommodation section 6 has an entry 8 that opens toward a front 9 of the trailer 1.

A set of stairs 10 is mounted at the front 9 of the trailer 1 behind the tow bar 5. The set of stairs 10 includes multiple flights 11. Three flights 11 are shown however more or less flights may be provided, as needed.

Each flight is formed of a riser 12 and a tread 13 rigidly fixed relative to a base 14 of the stairs 10. The lower two risers 12 have a panel 15 which can be hinged open to access a storage space beneath the respective treads 13. Locks 16 are provided to prevent unauthorised access to the storage space.

Side compartments 17, 18 project either side of the stairs 10 to provide additional storage such as for a gas bottle (not shown) or the like.

Handrails 19 are fixed to the treads by bolting or the like. The handrails 19 extend from the second tread 13 up to the top 7 of the trailer 1, adjacent the entry 8 of the accommodation section 6.

The base 14 is mounted across a V-section 20 of the chassis 4 by welding or bolting and a stepping plate 21 is fixed across beams 22, 23 of the chassis 4, between the stairs 10 and the tow bar 5 to provide a stable platform to climb the stairs 10.

A bracket 24 is connected to the beam 23 to support a clip of a step ladder 25. The step ladder 25 is preferably collapsible for transport. The step ladder 25 extends down to ground surface 26 to allow easy access from the ground surface 26 onto the stepping plate 21.

The steps 10 utilise space at the front 9 of the trailer 1 and connection to the chassis 4 to provide a solid, rigid and safe means of gaining access to a top 7 of the trailer 1 and accommodation section 6, without needing to use an un-safe or rickety ladder, while also providing additional storage options for the trailer 1.

The accommodation section 6 may also be removed from the trailer 1, in which case the set of steps 10 still provide reliable access to the top 7 of the trailer 1 from the upper tread 27, if needed.

What is claimed is:

1. A set of stairs arranged for mounting at a front of a trailer with a base adapted to be attached to a chassis of the trailer and stair flights leading up to a top of the trailer, each flight having a riser and a tread rigidly fixed relative to the base.

2. The set of stairs of claim 1, wherein one or more of the risers includes a panel to access a storage space beneath a respective tread.

3. The set of stairs of claim 1, further including fixed handrails that extend up to the top of the trailer.

4. The set of stairs of claim 1, further including one or more side compartments for holding a gas bottle or the like.

5. A trailer with the set of stairs defined in claim 1, including a chassis with the set of stairs mounted to the chassis, at a front of the trailer.

6. The trailer of claim 5, further including a stepping plate is fixed across the chassis between a tow bar and the set of stairs to provide a stable platform to climb the stairs.

7. The trailer of claim 5, further including a step ladder which is attached to a bracket connected to a beam of the chassis to provide access from a ground surface onto the stepping plate.

8. The trailer of claim 7, wherein the step ladder is collapsible and able to be removed from the bracket for transport.

9. The trailer of claim 5, further including an accommodation section on the top of the trailer, the accommodation section being moveable between a collapsed and assembled condition with an entry at the front of the trailer, adjacent an upper tread of the set of stairs.
